(19) United States
(12) Patent Application Publication
(10) Pub. No.: US 2016/0202749 A1
(43) Pub. Date: Jul. 14, 2016

(54) SYSTEM AND METHOD FOR DETERMINING CHARGE OF A SECONDARY POWER SUPPLY FOR A MEMORY SYSTEM

(71) Applicant: NetList, Inc., Irvine, CA (US)

(72) Inventor: Scott H. Milton, Irvine, CA (US)

(21) Appl. No.: 14/994,829

(22) Filed: Jan. 13, 2016

Related U.S. Application Data
(60) Provisional application No. 62/102,996, filed on Jan. 13, 2015.

(51) Int. Cl. G06F 1/30; G06F 11/14

(52) U.S. Cl. CPC G06F 1/30; G06F 11/1458; G06F 2201/86

(57) ABSTRACT

A memory system is described. The memory system includes one or more memory subsystems. The memory system also includes a power module coupled with at least one of the one or more memory subsystems. Further, the memory system includes a controller coupled with the one or more memory subsystems and the power module. The controller is configured to generate an energy threshold based on energy used for a backup operation.

### FIELD

Embodiments of the invention relate to memory systems. In particular, embodiments of the invention relate to memory systems with a secondary power supply.

### BACKGROUND

A memory system with a secondary power supply including those that include a volatile memory subsystem and a non-volatile memory subsystem configured to write contents of volatile memory into non-volatile memory. For example, such a memory system is configured to perform a backup operation upon detection of a power disruption or an impending disruption or failure. These memory systems include a secondary power supply to power the memory system during a power failure such that the memory system may perform a backup operation and transfer the information in the volatile memory subsystem into the non-volatile memory subsystem.

One problem with current memory systems is that it takes a significant amount of time for a secondary power supply to fully charge for a backup operation. During the time it takes the secondary power supply to fully charge, the memory system is not capable of performing a backup operation.

### SUMMARY

A memory system is described. The memory system includes one or more memory subsystems. The memory system also includes a power module coupled with at least one of the one or more memory subsystems. Further, the memory system includes a controller coupled with the one or more memory subsystems and the power module. The controller is configured to generate an energy threshold based on energy used for a backup operation.

Other features and advantages of embodiments of the present invention will be apparent from the accompanying drawings and from the detailed description that follows.

### BRIEF DESCRIPTION OF THE DRAWINGS

Embodiments of the present invention are illustrated by way of example and not limitation in the figures of the accompanying drawings, in which like references indicate similar elements and in which:

FIG. 1 illustrates a block diagram of a memory system configured to determine the charge of a secondary power supply according to an embodiment; and

FIG. 2 illustrates a flow diagram for a method to determine a charge of a secondary power supply for a memory system according to an embodiment.

### DETAILED DESCRIPTION

Embodiments of a system and method for determining a charge of a secondary power supply for a memory system are described. In particular, a memory system with a power module including a secondary power supply for the memory system is described that is configured to determine the energy used to perform a backup operation. The memory system then uses the energy used to perform the previous backup to set an energy threshold required for the next backup operation. Further, the memory system is configured to determine when the secondary power supply reaches the energy threshold.

Determining an energy threshold based on the energy used for a previous backup operation provides advantages over implementations that determined a threshold based on a charge voltage threshold set based on estimated worst case conditions and the end of life capacitance of the secondary power supply. Because such implementations are set up for worst-case conditions, these implementations are not based on actual operating conditions of a memory system. The worst case conditions and end of life capacitance charge voltage threshold are greater requiring more time for a secondary power supply to reach the charge voltage threshold. Further, a charge voltage threshold based on the worst case conditions and/or end of life capacitance charge voltage threshold are not based on actual operation conditions of a memory system. Thus, a memory system according to embodiments described herein are configured to determine an energy threshold for a power module based on a previous backup operation providing the benefit of reducing the amount of time a power module needs to charge before it is ready for a backup operation.

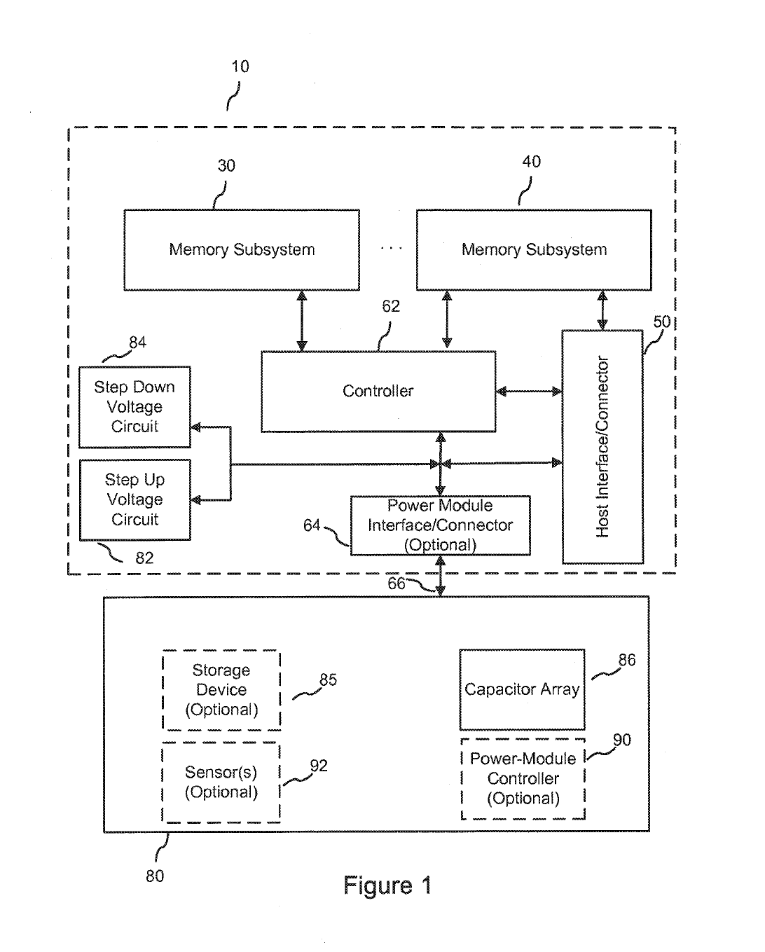

FIG. 1 illustrates a block diagram of a memory system configured to determine the charge of a secondary power supply according to an embodiment. The memory system includes a plurality of memory subsystems 30, 40. For an embodiment, the plurality of memory subsystems includes at least a volatile memory subsystem 30 and a non-volatile memory subsystem 40. The memory system 10 also includes a secondary power supply or a backup power supply such as a power module 80. The power module 80, according to an embodiment, includes a capacitor bank or array 86. For an embodiment, a capacitor bank or array 86 includes one or more capacitors coupled together in series and/or in parallel to form a super capacitor with an energy capacity to power a memory system. For an embodiment a capacitor array 86 is configured to have a capacitance in a range of 25 Farads to 100 Farads. In certain embodiments, the secondary power supply may include a battery. For example, the secondary power supply may include a battery and one or more capacitors.

For an embodiment the power module 80 includes a secondary power source for a memory system 10 that is used to power one or more memory subsystems of the memory system. By way of example and not limitation, a power module is used to power at least one volatile-memory subsystem 30 and at least one non-volatile memory subsystem 40 for a backup operation which includes transferring information from the volatile memory subsystem 30 to the non-volatile memory subsystem 40 during an interruption or failure of the primary power source of the memory system.

For an embodiment, a power module 80 optionally includes a storage device 85. The storage device 85 may be any type of memory including, but not limited to, electrically erasable programmable read-only memory (“EEPROM”), Flash, or other type of device used to store information. The storage device 85 may be used to store information related to the power module 80 including voltages, capacitance values, and energy values such as those described herein. A power module 80 also may optionally include a power-module controller 90 and one or more sensors 92. The one or more sensors 92 may be sensors including those known in the art configured to measure one or more characteristics of the power module 80 including, but not limited to, voltages, capacitance values, and energy values such as those described herein. The power-module controller 90 may be an I²C microcontroller slave or other type of controller such as those described herein. The power-module controller 90, according to an embodiment, is configured to manage the one or more sensors 92, communications with controller 62, or perform other operations including those known in the art.

The memory system 10, according to the embodiment illustrated in FIG. 1, includes a controller 62 coupled with the power module 80 through an optional connector 64. The controller 62 may include one or more of a field-programmable gate array (“FPGA”), a microcontroller, a memory controller, or other type of processor. For an embodiment, the controller 62 is coupled with the power module 80 through a data bus 66. A data bus 66 includes, but is not limited to, a parallel bus, a serial bus, an PC bus and other interconnections including those known in the art to transmit and receive data.

The memory system 10, according to the embodiment illustrated in FIG. 1, includes a step-up voltage circuit 82 and a step-down voltage circuit 84. The step-up voltage circuit 82 and a step-down voltage circuit 84 are coupled with the power module 80 through data bus 66. A step-up voltage circuit 82, for example, may be used to step-up a voltage received from a host through the host interface/connector 50 to a higher voltage than received to charge a capacitor array 86. A step-down circuit 84 may be used to step-down or regulate a voltage received from a power module 80 to a lower voltage level to power one or more circuits of the memory system 10. A step-down circuit may also be used instead of a step-up circuit to charge a capacitor array 86 using a voltage received from a host through the host interface/connector 50. The step-down circuit in such an embodiment is configured to step down a voltage received from the host through the host interface/connector 50.

According to the embodiment illustrated in FIG. 1, the memory system includes a host interface/connector 50 configured to interface with a host system. A host interface/connector 50 includes, but is not limited to, edge connectors which fit into a corresponding slot connector of a host system, such as connectors used on dual in-line memory modules, and other connector types including those known in the art. A host system includes, but is not limited to, a computer, a server, network equipment and other devices that are configured to use one or more memory system.

For an embodiment, controller 62 is configured to determine the energy used for a backup operation. The controller 62 determines the energy used for a back operation by measuring values of the capacitor array 86. The values measured by the controller 62 included the array voltage (“V_{SA}”) and the array capacitance (“C_{SA}”). For an embodiment, the controller 62 is configured to measure the array voltage periodically during the operation of the memory system when the memory system is not performing a backup operation. For another embodiment, the controller 62 is configured to measure the array voltage continuously. The controller 62 is also configured to measure the array voltage before a backup operation (“V_{SA,BB}”) is initiated by the controller 62. Further, controller 62 is configured to measure the array voltage after a backup operation (“V_{SA,AB}”). For an embodiment, the controller is configured to store the measured values in a memory internal to the controller 62 using techniques including those known in the art. For another embodiment, the controller 62 is configured to store measured values in a storage device 85 on the power module 80.

The controller 62 is further configured to calculate energy used for a backup operation (“E_{BU}”) based on the measured values according to the following equation:

$${E}_{BU} = \frac{{C}_{SA} ( {V}_{SA , BB}^{2} - {V}_{SA , AB}^{2} )}{2} .$$

For an embodiment, the controller 62 is configured to use the calculated energy used for a backup operation as an energy threshold for determining that the secondary power supply, such as the power module 80, has enough energy to perform a backup operation. For another embodiment, the controller 62 is configured to use the calculated energy used for a backup operation as a basis for an energy threshold. For such an embodiment, the controller 62 is configured to generate an energy threshold by adding a guard-band energy (“E_{GB}”) to the calculated energy to perform a backup operation. The guard-band energy may be selected to ensure proper operation of a backup operation.

According to an embodiment, the guard-band energy may be determined empirically or may be based on design specifications of a power module. The guard band energy ensures a memory system operates reliability in different operation conditions. More guard band means that the system can accommodate larger fluctuations in either backup time or backup power draw. Adding additional guard band comes at the expense of adding additional charging time. For example, a guard-band energy is set to be in a range including 10% to 100% of the energy used for a backup operation.

For another embodiment, the controller 62 is configured to use the calculated energy used for a backup operation in addition to a drop-out energy (“E_{DO}”) as a basis for an energy threshold. For such an embodiment, controller 62 is configured to generate an energy threshold by adding a drop-out energy (“E_{DO}”) to the calculated energy to perform a backup operation. The drop-out energy, according to an embodiment, is determined based on a minimum voltage at which a secondary power supply can no longer provide power to a memory system. By way of example, a drop-out energy may be equal to the energy left in a power module 80 when the voltage level of the power module reaches 2.5 volts. The drop-out energy, according to an embodiment, is based on a minimum voltage requirement for one or more circuits of the memory system 10. For example, the drop-out energy may be based on the minimum voltage need by a voltage regulator or step-down voltage circuit to function to provide power from the secondary power supply to the memory system 10, otherwise referred to herein as the drop-out voltage (“V_{DO}”). For an embodiment, the drop-out energy may be calculated according to the follow equation:

$${E}_{DO} = \frac{{C}_{SA} {V}_{DO}^{2}}{2} .$$

For an embodiment, the controller 62 is configured to generate an energy threshold by adding a drop-out energy (“E_{DO}”) to the calculated energy threshold to perform a backup operation in addition to a guard-band energy. For such an embodiment, the controller 62 is configured to generate an energy threshold (“E_{TH}”) according to the following equation:

E_{TH}=E_{BU}+E_{DO}E_{GB}.

For any of the embodiments described herein, the controller 62 is configured to determine if a secondary power supply such as a power module 80 has enough energy to perform a backup operation when the energy of the power module is equal to or greater than the generated energy threshold based on techniques including those described herein. For such embodiments, when the energy of the power module is equal to or greater than the threshold energy, the controller 62 determines that the power module 80 has enough energy for a backup operation. The controller 62 is configured to compare the energy of the power module 80 with the energy threshold using techniques known in the art for comparing the magnitudes of two values.

For another embodiment, the controller 62 is configured to determine if a secondary power supply such as a power module 80 has enough energy to perform a backup operation based on the voltage of the power module 80. The controller 62 is configured to calculate a voltage threshold (“V_{TH}”) according to the following equation:

$${V}_{TH} = \sqrt{\frac{2 {E}_{TH}}{{C}_{SA}}} .$$

The controller 62 is further configured to compare the voltage of the power module 80, such as an array voltage, with the threshold voltage. The controller 62 is configured to compare the voltage of the power module 80 with the voltage threshold using techniques known in the art for comparing the magnitudes of two values. When the voltage of the power module is equal to or greater than the threshold voltage, the controller 62 determines that the power module 80 has enough energy for a backup operation. The values described herein used to generate a threshold energy or threshold voltage may be based on the values measured, calculated, or otherwise determined by a controller 62 during a previous backup operation. Alternatively, the values may be based on average values measured, calculated, or otherwise determined by the controller 62 over a number of backup operations. When the controller 62 determines that the energy or the voltage of the power module 80 is equal to or greater than the threshold energy or the threshold voltage, respectively, the controller 62 determines that the power module 80 is charged for a backup operation.

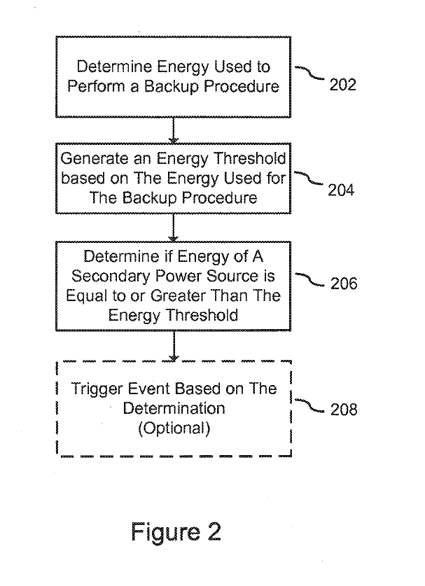

FIG. 2 illustrates a flow diagram for a method to determine energy of a secondary power supply for a memory system according to an embodiment. Such a method may be performed by a system including those described herein. The method determines energy used to perform a backup operation at step 202 using techniques including those described herein. At step 204, the method generates an energy threshold based on the energy used for the backup operation according to techniques including those described herein. At step 206, the method determines if the energy of a secondary power source is equal to or greater than the energy threshold according to techniques including those described herein. The method at step 208 optionally triggers an event based on the determination if the energy of the secondary power source is equal to or greater than the energy threshold. For an embodiment, a determination that the energy of the secondary power source is less than the threshold value a notification may be set to indicate that the memory system does not have the energy needed to perform a backup operation. For another embodiment, a determination that the energy of the secondary power source is equal to or greater than the threshold value a notification may be set to indicate that the memory systems does have the energy needed to perform a backup operation.

For an embodiment, the controller may trigger an event or otherwise notify a host system based on the determination of the energy of a secondary power supply. The controller 62, according to an embodiment, may be configured to trigger an event by setting a bit, accessing an address register, accessing a data register, setting a control bit, setting a status bit, setting an error bit or using other techniques known in the art for notifying a system of a condition.

In the foregoing specification, specific exemplary embodiments of the invention have been described. It will, however, be evident that various modifications and changes may be made thereto. The specification and drawings are, accordingly, to be regarded in an illustrative rather than a restrictive sense.

What is claimed is:

1. A memory system comprising:
one or more memory subsystems;
a power module coupled with at least one of said one or more memory subsystems; and
a controller coupled with said one or more memory subsystems and said power module, said controller configured to generate an energy threshold based on energy used for a backup operation.

2. The memory system of claim 1, wherein the controller is further configured to use the energy threshold to determine when said power module is charged for a backup operation.

3. The memory system of claim 1, wherein said controller is configured to generate said energy threshold by adding a guard-band energy to said energy used for said backup operation.

4. The memory system of claim 3, wherein said controller is configured to generate said energy threshold by further adding a drop-off energy to said guard-band energy and to said energy used for said backup operation.

5. The memory system of claim 1, wherein said energy used for said backup operation is an average energy used for a number of backup operations.

6. The memory system of claim 1, wherein said controller is further configured to determine an energy of said power module.

7. The memory system of claim 6, wherein said controller is further configured to determine if said energy of said power module is equal to or greater than said energy threshold.

8. The memory system of claim 7, wherein said controller is configured to trigger an event if said energy of said power module is less than said energy threshold.

9. The memory system of claim 7, wherein said controller is configured to trigger an event if said energy of said power module is equal to or greater than said energy threshold.

10. The memory system of claim 1, wherein said secondary power module includes a capacitor array.

11. A method comprising:
at a memory system including a plurality of memory subsystems and a secondary power source:
determining energy used to perform a backup operation;
generating an energy threshold based on said energy used for said backup operation; and
determining if said energy of said secondary power source is equal to or greater than said energy threshold.

12. The method of claim 11, wherein generating said energy threshold includes adding a guard-band energy to said energy used for said backup operation.

13. The method of claim 12, wherein generating said energy threshold further includes adding a drop-out energy to said guard-band energy and to said energy used for said backup operation.

14. The method of claim 13, wherein said drop-out energy is based on a minimum voltage requirement of a circuit in said memory system.

15. The method of claim 13 further comprising triggering an event if said energy of said power module is less than said energy threshold.

16. The method of claim 11 further comprising triggering an event if said energy of said power module is equal to or greater than said energy threshold.

17. The method of claim 11, wherein determining if said energy of said secondary power source is equal to or greater than said energy threshold is based on a comparison of a capacitor array voltage to a threshold voltage.

18. A memory system comprising:
a means for determining energy used to perform a backup operation;
a means for generating an energy threshold based on said energy used for said backup operation; and
a means for determining if said energy of said secondary power source is equal to or greater than said energy threshold.

19. The memory system of claim 18 further comprising a means for triggering an event if said energy of said power module is less than said energy threshold.

20. The memory system of claim 18 further comprising a means for triggering an event if said energy of said power module is equal to or greater than said energy threshold.
